(19) United States
(12) Patent Application Publication
(10) Pub. No.: US 2025/0014157 A1
(43) Pub. Date: Jan. 9, 2025

(54) AUTOMATED IMAGE EVALUATION, AUTOMATED SETTING OF PROCESSING PARAMETERS, IMAGE PROCESSING, IMAGE PROCESSING SYSTEM, AND IMAGE ANALYSIS UNIT

(71) Applicant: Robert Bosch GmbH, Stuttgart (DE)

(72) Inventors: Benedikt Biedermann, Loerrach (DE); Jonas Daniel Stoll, Marxzell (DE); Sebastian Johann Hermann Konopka, Stuttgart (DE); Syed Salman Haider Zaidi, Leonberg (DE)

(21) Appl. No.: 18/751,716

(22) Filed: Jun. 24, 2024

(30) Foreign Application Priority Data
Jul. 3, 2023 (DE) 10 2023 206 255.0

(51) Int. Cl. G06T 7/00

(52) U.S. Cl. CPC G06T 7/00

(57) ABSTRACT

A computer-implemented method for automated image evaluation, a computer-implemented method for automated setting of processing parameters of an image processing processor, and a computer-implemented method for image processing of input images of an image sensor. An image processing system and an image analysis unit are also described.

### CROSS REFERENCE

The present application claims the benefit under 35 U.S.C. § 119 of German Patent Application No. DE 10 2023 206 255.0 filed on Jul. 3, 2023, which is expressly incorporated herein by reference in its entirety.

### FIELD

The present invention relates to a computer-implemented method for automated image evaluation, to a computer-implemented method for automated setting of processing parameters of an image processing processor, and to a computer-implemented method for image processing of input images of an image sensor. Furthermore, the present invention relates to an image processing system and an image analysis unit.

### BACKGROUND INFORMATION

Some conventional image processing processors are designed that play a critical role in digital image processing, as highly specialized microprocessors. The image processing processors are also commonly referred to as image signal processors (ISPs) and have the ability to process high-dynamic-range raw images provided by an image sensor and to convert them into a format that is useful for image analysis. This process makes it possible to create digital images in a form that can be effectively interpreted and analyzed by computer applications and processing algorithms.

Image processing algorithms which can be configured via processing parameters are incorporated into the image processing processor. These image processing algorithms perform a series of functions in order to enhance the input image and optimize it for use by the image analysis. For example, they can sharpen the input image, correct colors, reduce noise, and carry out other forms of image optimization.

A challenge in developing an image processing system is to find suitable processing parameters that are optimally adapted to the specific image analysis requirements. This means that the image processing system must be able to extract the maximum amount of information from the input image in order to maximize the performance of the image analysis.

A conventional procedure for setting the processing parameters comprises several steps. First, images are created manually and various assumptions are made about the optimal image representation for the image analysis. The next step is to evaluate an individual parameter set of the processing parameters. This is done by an image quality expert, often referred to as a “golden eye,” who examines the output image of the image processing by visual inspection on a computer monitor. Moreover, the image quality expert evaluates various characteristic curves, such as noise characteristics, in particular in order to obtain a comprehensive assessment of the image quality and the efficacy of the processing parameters.

This process requires a high level of expertise and experience in order to ensure that the processing parameters are optimally adapted to the requirements of the image analysis and provide the best possible image quality.

### SUMMARY

According to the present invention, a computer-implemented method is provided. According to the present invention, the image evaluation can thereby be carried out objectively and comprehensibly. The image quality of the processed input images is increased. A subsequent image analysis can be implemented more reliably, accurately, and quickly. The image evaluation can be carried out independently of display devices to be read by an image quality expert.

The computer-implemented method can be used in a semiautonomous or autonomous system. The system may, for example, be a vehicle or a robot.

According to an example embodiment of the present invention, the image evaluation can identify an image property of the output image. The image property may be an image sharpness, an image resolution, a color depth, an exposure, a contrast, and/or noise of the input image.

An image processing processor is understood to mean a microprocessor specifically for processing digital images. The image processing processor may be dedicated or integrated into a higher-level microprocessor.

The input images may be generated by an image sensor. The input images may be raw images of the image sensor. The input images may be present as individual images or as an image sequence.

The input images may be images of an environment, in particular a vehicle environment of a vehicle. The input images may be present as digital images.

According to an example embodiment of the present invention, the processing parameters may be parameters for noise suppression, sharpening, white balance, exposure, color correction, objective correction, demosaicing, and/or compression. The compression may be a bit-depth reduction and/or may use JPEG or HEIF compression formats.

According to an example embodiment of the present invention, the image evaluation result can be output for recording by a user. The image evaluation result may have at least one piece of evaluation information. The image evaluation result may be output via a REST API.

The image evaluation result of an output image can be calculated independently of a comparison with the corresponding input image.

The image property may be an image quality and/or image suitability for a subsequent image analysis.

According to an example embodiment of the present invention, the image evaluation algorithm may be performed separately from the image analysis. The image evaluation algorithm may be a blind/no-reference image spatial quality evaluator (BRISQUE), in which an image quality is evaluated by measuring spatial aberrations in an image. The image evaluation algorithm may be a naturalness image quality evaluator (NIQE), which applies statistical features to evaluate the image quality. The image evaluation algorithm may be a perceptual image quality assessment (PIQA), which uses machine learning to simulate human perception models for the image quality. The image evaluation algorithm may be a blind/no-reference image sharpness metric (BRISM), in which the sharpness of an image is measured. The image evaluation algorithm may be a no-reference quality metric (NRQM), in which the image quality is calculated on the basis of features such as brightness, contrast, and color saturation.

The image evaluation algorithm may be performed during the image analysis. The image evaluation result can thereby be directly calculated depending on the influence on the image analysis.

The autonomous system can be controllable depending on the image analysis.

The computer-implemented method may be performed in a software container.

In a preferred embodiment of the present invention, it is advantageous if the image evaluation algorithm processes the output images by means of machine learning. Machine learning may take place by applying neural networks, decision trees, and/or support vector machines (SVM). The neural networks may be convolutional neural networks. The neural networks may be taught by means of deep learning.

According to an example embodiment of the present invention, the present invention, a computer-implemented method for automated setting of processing parameters of an image processing processor is also provided. The processing parameters may be set depending on a taught relationship between the processing parameters and the image evaluation result. The relationship may be taught by means of machine learning.

According to an example embodiment of the present invention, the computer-implemented method may be performed in a software container. The software container and the software container on which the computer-implemented method for automated image evaluation runs may be the same or different.

The automatedly set processing parameters may be some or all of the processing parameters of the image processing processor.

In a specific embodiment of the present invention, it is advantageous if a numerical optimizer outputs proposed processing parameters depending on the image evaluation result. The numerical optimizer may use a gradient descent method, evolutionary algorithms, and/or a swarm optimization.

According to an example embodiment of the present invention, the numerical optimizer may be assigned to the image evaluation algorithm. The numerical optimizer may be designed to be separate from the image evaluation algorithm, in particular downstream thereof. The processing parameters may be transmitted, in particular set, via a REST API.

The image evaluation algorithm may be assigned to the image analysis, and the image evaluation result may be formed depending on the result of the image analysis. As a result, an application-related image evaluation can be performed. The image evaluation algorithm may also take place separately from the image analysis.

In a specific embodiment of the present invention, it is advantageous if the proposed processing parameters are used in the image processing processor. The proposed processing parameters may at least partially replace the previously preset processing parameters.

In a specific embodiment of the present invention, it is advantageous if the input images processed with the proposed processing parameters are in turn transferred as output images to the image evaluation algorithm, which outputs a new image evaluation result therefrom, wherein the new image evaluation result is used to calculate re-proposed processing parameters. As a result, multiple feedback can be executable for optimally setting the processing parameters.

In a specific embodiment of the present invention, it is advantageous if the re-proposed processing parameters are used in the image processing processor. The re-proposed processing parameters may at least partially replace the previously proposed and set processing parameters.

According to the present invention, a computer-implemented method is also provided. The image processing can thereby calculate more suitable output images for the image analysis.

According to the present invention, an image processing system is also provided.

According to the present invention, an image analysis unit is also provided. The image analysis unit can be validated, verified and/or trained, in particular re-trained, with the output images processed starting from the input images by the processing parameters of the image processing processor that are set depending on the image evaluation result.

According to an example embodiment of the present invention, the image analysis can analyze the output images by means of machine learning. The machine learning can take place by applying neural networks and/or support vector machines (SVM). The neural networks may be convolutional neural networks. The neural networks may be taught by means of deep learning. The image analysis can analyze the output images by applying traditional algorithms, such as optical flow or disparity.

According to an example embodiment of the present invention, the image analysis may comprise an image interpretation, object detection, for example a person detection, a vehicle detection, a traffic sign detection, trajectory analysis, object classification, scene detection, and/or segmentation, which means dividing the image into various regions each representing various objects or portions of the scene.

According to an example embodiment of the present invention, the first image processing, the second image processing, and the image analysis may be performed in separate software modules or in at least partially common software modules. The software modules may be executed in a cloud-based manner and/or locally.

The software modules may be executed by distributed computing in individual nodes. As a result, the processing operations can be carried out in parallel and can be scalable.

Further advantages and advantageous embodiments of the present invention emerge from the description of the figures and from the figures.

### BRIEF DESCRIPTION OF THE DRAWINGS

The present invention is described in detail below with reference to the figures.

FIG. 1 shows a computer-implemented method for image processing, an image processing system, and an image analysis unit, each in a specific example embodiment of the present invention.

FIG. 2 shows a computer-implemented method for automated image evaluation in a specific example embodiment of the present invention.

FIG. 3 shows a computer-implemented method for automated setting of processing parameters in a specific example embodiment of the present invention.

### DETAILED DESCRIPTION OF EXAMPLE EMBODIMENTS

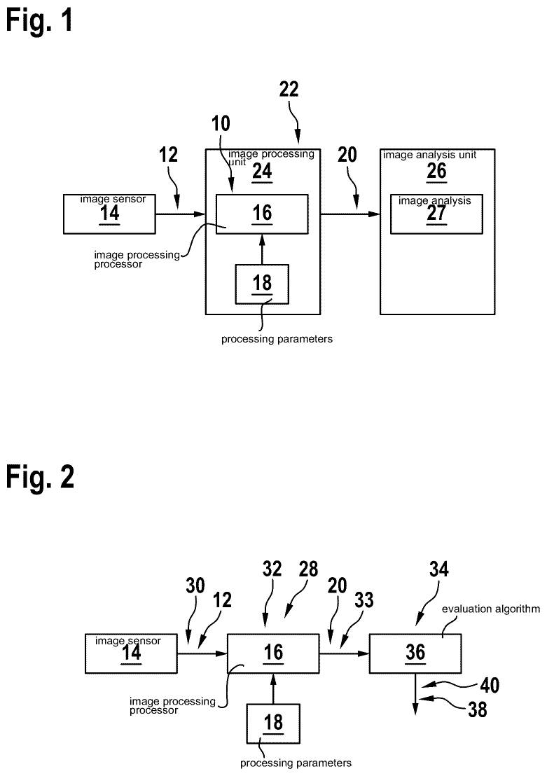

FIG. 1 shows a computer-implemented method for image processing, an image analysis unit, and an image processing system, each in a specific example embodiment of the present invention. The computer-implemented method for image processing 10 of input images 12 is, for example, performed to analyze the input images 12. The input images 12 may be images of an environment of a vehicle, which are interpreted by the image analysis.

The input images 12 are provided as raw images by an image sensor 14 and are processed by an image processing processor 16 depending on processing parameters 18 of the image processing processor 16. The processing parameters 18 may influence a brightness, depth of color, or the like of the input images 12. The image processing processor 16 outputs the input images 12 processed in this manner as output images 20. The output images 20 thus differ, mostly due to the application of the processing parameters 18, from the input images 12 in the image properties influenced by the processing parameters 18.

An image processing system 22 comprises an image processing unit 24 with the image processing processor 16. The image processing unit 24 is configured to perform the computer-implemented method for image processing 10.

The output images 20 can be processed by an image analysis unit 26. The image analysis unit 26 performs an image analysis 27, for example an image interpretation, object detection, trajectory analysis, object classification, scene detection, and/or segmentation, of the output images 20, as input images 12 processed by the image processing system 22.

FIG. 2 shows a computer-implemented method for automated image evaluation in a specific example embodiment of the present invention. The computer-implemented method for automated image evaluation 28 of input images 12 processed by an image processing processor 16 comprises, first, providing 30 the input images 12 by means of an image sensor 14. Subsequently, a first image processing 32 of the input images 12 takes place by an image processing processor 16 depending on processing parameters 18 of the image processing processor 16, and the processed input images 12 are output 33 as output images 20. With a subsequent second image processing 34 of the output images 20 by means of a taught image evaluation algorithm 36, an image evaluation result 38 is formed depending on the second image processing 34, wherein the image evaluation result 38 indicates at least one image property on which a subsequent image analysis of the output images 20 depends. The image evaluation algorithm 36 can process the output images 20 by means of machine learning.

For example, the image evaluation algorithm 36 can have been taught with both input images 12 processed by the first image processing 32 with preset processing parameters 18 and reference images to create an image evaluation result 38. Subsequently, the image evaluation result 38 is output 40, for example for automated setting of the processing parameters 18.

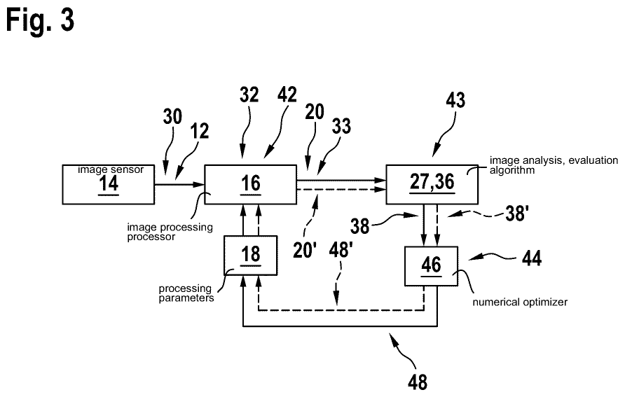

FIG. 3 shows a computer-implemented method for automated setting of processing parameters in a specific embodiment of the present invention. The computer-implemented method for automated setting 42 of processing parameters 18 of an image processing processor 16 may be an extension of the computer-implemented method for automated image evaluation described in FIG. 2.

In the computer-implemented method for automated setting 42 of processing parameters 18, input images 12 are provided 30 first and, thereafter, a first image processing 32 of the input images 12 takes place by an image processing processor 16 depending on the processing parameters 18 of the image processing processor 16. Subsequently, the processed input images 12 are output 33 as output images 20, and the automated image evaluation is performed 43 by the computer-implemented method for automated image evaluation, for example as described in FIG. 2. Furthermore, the processing parameters 18 are set 44 depending on the image evaluation result 38.

For example, the image evaluation algorithm 36 can have been taught with both input images 12 processed by the first image processing 32 with preset processing parameters 18 and reference images to create an image evaluation result 38. As shown here, the image evaluation algorithm 36 is assigned to the image analysis 27, and the image evaluation result 38 can be formed depending on the result of the image analysis 27. As a result, an application-related image evaluation and calculation of the image evaluation result 38 can be performed. The image analysis 27 preferably corresponds to the image analysis used in the later application, which analyzes output images processed with the automatedly set processing parameters 18.

With a numerical optimizer 46, the processing parameters 18 are calculated starting from the evaluation result 38 and are output as proposed processing parameters 48.

The automated setting 44 may comprise several optimization steps. The proposed processing parameters 48 are first used in the image processing processor 16. The input images 12 processed with the proposed processing parameters 48 are in turn transferred as output images 20′ to the image evaluation algorithm 36, which therewith creates a new image evaluation result 38′, from which the numerical optimizer 46 outputs re-proposed processing parameters 48′. In turn, the re-proposed processing parameters 48′ are used in the image processing processor 16 until an optimal setting of the processing parameters 18 is present.

What is claimed is:

1. A computer-implemented method for automated image evaluation of input images processed by an image processing processor, comprising the following steps:
providing the input images;
first image processing of the input images by the image processing processor depending on processing parameters of the image processing processor;
outputting the processed input images as output images;
second image processing of the output images by a taught image evaluation algorithm; and
outputting an image evaluation result depending on the second image processing, wherein the image evaluation result indicates at least one image property of the output images on which a subsequent image analysis of the output images depends.

2. The computer-implemented method according to claim 1, wherein the image evaluation algorithm processes the output images using machine learning.

3. A computer-implemented method for automated setting of processing parameters of an image processing processor, comprising the following steps:
providing input images;
first image processing of the input images by an image processing processor depending on processing parameters of the image processing processor;
outputting the processed input images as output images;
performing an automated image evaluation by:
second image processing of the output images by a taught image evaluation algorithm; and
outputting an image evaluation result depending on the second image processing, wherein the image evaluation result indicates at least one image property of the output images on which a subsequent image analysis of the output images depends; and
setting the processing parameters depending on the image evaluation result.

4. The computer-implemented method according to claim 3, wherein a numerical optimizer outputs proposed processing parameters depending on the image evaluation result.

5. The computer-implemented method according to claim 4, wherein the proposed processing parameters are used in the image processing processor to processing the input images.

6. The computer-implemented method according to claim 5, wherein the input images processed with the proposed processing parameters are transferred as output images to the image evaluation algorithm, which outputs a new image evaluation result from the output images, wherein a new image evaluation result is used to calculate re-proposed processing parameters.

7. The computer-implemented method according to claim 6, wherein the re-proposed processing parameters are used in the image processing processor to process the input images.

8. The computer-implemented method according to claim 3, wherein first input images from an image sensor are processing by the image processor depending on the set processing parameters.

9. An image processing system for image processing of input images of an image sensor, comprising:
an image processing unit configured to process first input images from an image sensor, the image processing unit including at least one image processing processor processing the first input images depending on set processing parameters, the processing parameters being set by:
providing input images,
first image processing of the input images by an image processing processor depending on processing parameters of the image processing processor,
outputting the processed input images as output images,
performing an automated image evaluation by:
second image processing of the output images by a taught image evaluation algorithm, and
outputting an image evaluation result depending on the second image processing, wherein the image evaluation result indicates at least one image property of the output images on which a subsequent image analysis of the output images depends, and
setting the processing parameters depending on the image evaluation result.

10. An image analysis unit for image analysis of input images processed by an image processing system, the image processing system including:
an image processing unit configured to process first input images from an image sensor, the image processing unit including at least one image processing processor processing the first input images depending on set processing parameters, the processing parameters being set by:
providing input images,
first image processing of the input images by an image processing processor depending on processing parameters of the image processing processor,
outputting the processed input images as output images,
performing an automated image evaluation by:
second image processing of the output images by a taught image evaluation algorithm, and
outputting an image evaluation result depending on the second image processing, wherein the image evaluation result indicates at least one image property of the output images on which a subsequent image analysis of the output images depends, and
setting the processing parameters depending on the image evaluation result.
